(19) United States
(12) Patent Application Publication
(10) Pub. No.: US 2006/0166041 A1
(43) Pub. Date: Jul. 27, 2006

(54) Magnetic recording medium, and magnetic recording and reproducing methods

(75) Inventors: Toshiharu Takeda, Kanagawa (JP); Toshichika Aoki, Kanagawa (JP); Tomoko Yamamuro, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/340,513

(22) Filed: Jan. 27, 2006

(30) Foreign Application Priority Data
Jan. 27, 2005 (JP) P.2005-019330

(51) Int. Cl. G11B 5/708

(52) U.S. Cl. 428/842

(57) ABSTRACT

A magnetic recording medium comprising: a nonmagnetic support; and a magnetic layer comprising a binder and ferromagnetic powder dispersed in the binder, wherein the magnetic layer has a surface waviness of from 3 to 15%, the surface waviness being calculated by {[(a total of cross-sectional areas of the magnetic layer at a position 5 nm in an above direction from an average plane of surface waviness of the magnetic layer)+(a total of cross-sectional areas of the magnetic layer at a position 5 nm in a below direction from the average plane of surface waviness of the magnetic layer)] (μm²)/a area of a surface of the magnetic layer to be measured (μm²)}×100(%).

### FIELD OF THE INVENTION

The present invention relates to a magnetic recording medium and magnetic recording and reproducing methods, in particular, relates to a magnetic recording medium contrived to reduce spacing loss, restrained in dropout, and suitable for using a reproducing head (an MR head) utilizing a magneto-resistive element (an MR element), and magnetic recording and reproducing methods.

### BACKGROUND OF THE INVENTION

In the field of magnetic tapes for data backup, with the increase of capacity of hard discs applying to backups, those having storage capacity of 200 GB or more per a roll are now no the market, so that the increase of capacity of magnetic tapes for data backup to cope with further increment of capacity of hard discs is indispensable.

For the increment of capacity of a backup tape per a roll, it is necessary to thin the thickness of a tape at large to lengthen a tape length per a roll and to make the thickness of a magnetic layer as thin as 0.15 μm or less to thereby minimize thickness loss and to shorten recording wavelength, as well as to narrow track width 7 μm or less to heighten the recording density in the width direction.

However, thinning of a magnetic layer thickness to 0.15 μm results in the deterioration of durability, so that it is necessary to provide at least an undercoat layer between a nonmagnetic support and a magnetic layer. Moreover, when recording wavelength becomes short, the influence of spacing between a magnetic layer and a magnetic head becomes large, and so if there are any defects on the surface of a magnetic layer, the half value width (PW 50) of output peak broadens, or output lowers and an error rate becomes high. In addition, when a track width is made as narrow as 7 μm or less to increase the recording density in the width direction, leakage flux from the magnetic recording medium becomes small, so that it is necessary to use an MR head as the reproducing head capable of obtaining high output even with micro-flux.

There is disclosed in JP-A-2001-84549 (The term “JP-A” as used herein refers to an “unexamined published Japanese patent application”.) a magnetic recording medium comprising a support having formed thereon a magnetic layer mainly comprising ferromagnetic powder and a binder with the object of improving a fatal error leading to actual damage, which is for use in magnetic recording and reproducing methods of linear serpentine system adopting RLL2-7 modulation, wherein the surface of the magnetic layer has cavities having depths of 50 nm or more of 10/46,237.5 μm² or less measured by non-contact type surface roughness meter and the maximum depth Rv of 100 nm or less. However, it has been found from the investigation by the present inventor that merely controlling the number of the cavities having a depth of 50 nm or more on the surface of a magnetic layer cannot reduce the generation of dropout in high density digital recording.

### SUMMARY OF THE INVENTION

An object of the invention is to provide a magnetic recording medium contrived to reduce spacing loss, restrained in dropout, and suitable for using an MR head, and magnetic recording and reproducing methods.

The present inventor has found it is effective to control the waviness of a magnetic layer surface to restrain dropout in performing high density recording of recording wavelength of 0.3 μm or less.

That is, the present invention is as follows.

(1) A magnetic recording medium comprising:

a nonmagnetic support; and

a magnetic layer comprising a binder and ferromagnetic powder dispersed in the binder,

wherein the magnetic layer has a surface waviness of from 3 to 15%, the surface waviness being calculated by {[(a total of cross-sectional areas of the magnetic layer at a position 5 nm in an above direction from an average plane of surface waviness of the magnetic layer)+(a total of cross-sectional areas of the magnetic layer at a position 5 nm in a below direction from the average plane of surface waviness of the magnetic layer)] (μm²)/a area of a surface of the magnetic layer to be measured (μm²)}×100(%).

(2) The magnetic recording medium as described in the above item (1), wherein the surface waviness is measured at a tension of a sample of 100 g per ½ inch.

(3) The magnetic recording medium as described in the above item (1), wherein the surface waviness is measured according to the following measuring conditions:

Measuring Instrument:

Three dimensional surface profiler New View 5022 manufactured by ZYGO Corporation

Measuring Method:

Scanning white light interferometry

Scan Length in Z Direction: 5 μm

Tension of a Sample at Measuring: 100 g per ½ Inch

Area of Field of View in Measurement:

700 μm×522 μm (object lens: 20 magnifications, image zoom: 0.5 magnifications)

Filter Treatment:

High pass filter 50 μm, low pass filter OFF

Surface Waviness (%):

{[(a total of cross-sectional areas of the magnetic layer at a position 5 nm in an above direction from an average plane of surface waviness of the magnetic layer)+(a total of cross-sectional areas of the magnetic layer at a position 5 nm in a below direction from the average plane of surface waviness of the magnetic layer)] (μm²)/the area of field of view in measurement (μm²)}×100(%).

(4) The magnetic recording medium as described in any one of the above items (1) to (3), wherein the surface waviness is from 3 to 10%.

(5) The magnetic recording medium as described in any one of the above items (1) to (3), wherein the surface waviness is from 3 to 8%.

(6) The magnetic recording medium as described in any one of the above items (1) to (5), wherein a nonmagnetic layer comprising nonmagnetic inorganic powder dispersed in a binder is provided between the nonmagnetic support and the magnetic layer.

(7) The magnetic recording medium as described in any one of the above items (1) to (6), wherein the ferromagnetic powder is ferromagnetic metal powder having an average long axis length of from 20 to 70 nm.

(8) The magnetic recording medium as described in any one of the above items (1) to (7), wherein the thickness of the magnetic layer is from 0.01 to 0.15 μm.

(9) A magnetic recording or reproducing method of recording or reproducing an information with a magnetic recording medium that comprises a nonmagnetic support having provided thereon at least a magnetic layer comprising ferromagnetic powder dispersed in a binder, wherein the magnetic recording medium is the magnetic recording medium as described in any one of the above items (1) to (8), and a reproducing head utilizing a magneto-resistive element is used as a reproducing means of the information.

(10) The magnetic recording or reproducing method as described in the above item (9), wherein the recording wavelength of information is from 0.05 to 0.30 μm.

The present invention can provide a magnetic recording medium contrived to reduce spacing loss, restrained in dropout, and suitable for using an MR head by controlling the surface waviness of the magnetic layer surface, and magnetic recording and reproducing methods.

### DETAILED DESCRIPTION OF THE INVENTION

The invention is described in detail below.

The invention is characterized in that in a magnetic recording medium that comprises a nonmagnetic support having provided thereon at least a magnetic layer comprising ferromagnetic powder dispersed in a binder, the surface waviness of the magnetic layer is from 3 to 15%.

The surface waviness in the invention can be controlled according to the following method.

Method for Controlling Waviness of Nonmagnetic Support:

Surface waviness in the invention can be achieved by controlling the waviness of a nonmagnetic support itself. As the forming methods of a nonmagnetic support, for example, there are a film-forming method by melting a polymer (melt film-forming) and a film-forming method by casting a polymer solution (solution film-forming). In the case of melt film-forming, a primer layer is generally provided for the purpose of controlling the surface properties of a support and easy adhesion treatment of the layer provided on the support, and the surface waviness of the support can be controlled by controlling drying condition after forming the primer layer. Waviness generally becomes large by increasing the drying speed. The drying speed is determined by the kind of solvent used in the primer layer, coating speed, drying temperature and the amount of drying air. In the case of solution film-forming, the surface waviness of a support can be controlled by controlling the drying condition for removing the solvent after casting a polymer solution. Specifically, waviness becomes large by increasing the drying speed. The drying speed is determined by the kind of solvent used in the polymer solution, coating speed, the amount of drying air, and the moisture content in drying air.

Method for Providing Undercoat Layer:

As another means of controlling the surface waviness of a magnetic layer, it is preferred to provide an undercoat layer between a magnetic layer and a nonmagnetic support, and it is more preferred that the undercoat layer is a radiation-curable layer. The undercoat layer can be formed by coating an under layer-forming coating solution containing a binder and a radiation-curable compound each shown below on a nonmagnetic support, drying, and curing by irradiation with radiation.

Binder of Undercoat Layer:

As the binders for use in an undercoat layer, organic solvent-soluble thermoplastic resins, thermosetting resins, reactive resins and mixture of these resins conventionally known are exemplified. Specifically, polyamide resins, polyamideimide resins, polyester resins, polyurethane resins, vinyl chloride resins and acrylic resins are exemplified. Further, in coating a non magnetic layer and/or a magnetic layer after forming an undercoat layer, there are cases where the undercoat layer swells or dissolves by the solvents contained in the nonmagnetic layer and the magnetic layer, so that the surface properties suffer deterioration. In such a case, the binders of the undercoat layer are preferably those not soluble in the solvents contained in the nonmagnetic layer and the magnetic layer but soluble in other organic solvents.

The glass transition temperature of the binders is preferably from 0 to 120° C., more preferably from 10 to 80° C. When the glass transition temperature is 0° C. or more, blocking at the end part does not occur, and when it is 120° C. or less, the internal stress of the undercoat layer can be relaxed and excellent adhesion can also be secured. Binders having mass average molecular weight of from 1,000 to 100,000 can be used in the invention, and binders having mass average molecular weight in the range of from 5,000 to 50,000 are especially preferred. When the mass average molecular weight is 1,000 or more, blocking at the end part does not occur, and when it is 100,000 or less, the binders are well dissolved in organic solvents and coating of an undercoat layer can be carried out satisfactorily.

Radiation-Curable Compound:

The “radiation-curable compounds” contained in an undercoat layer coating solution are compounds having the properties of initiating polymerization or crosslinking to be polymerized and cured upon irradiation with radiation, e.g., ultraviolet rays or electron beams. Radiation-curable compounds do not undergo reaction so long as external energy (ultraviolet ray or radiation) is not given. Accordingly, coating solutions containing radiation-curable compounds are stable in viscosity so long as not irradiated with ultraviolet ray or radiation and a very smooth film can be obtained. Further, reaction progresses in a moment due to high energy such as ultraviolet ray or radiation, very high film strength can be obtained with coating solutions containing radiation curable compounds.

Various kinds of radiations, e.g., X-ray, α-ray, β-ray and γ-ray, can be used in the invention.

The molecular weight of radiation-curable compounds is preferably in the range of from 200 to 2,000, more preferably from 200 to 1,500, and still more preferably from 300 to 1,000. When the molecular weight is in the above range, the coating solution is flowable and a smooth film can be formed.

The coefficient of viscosity of radiation-curable compounds is preferably in the range of from 100 to 40,000 cP (from 0.1 to 40 Pa·s), more preferably from 1,000 to 40,000 cP (from 1 to 40 Pa·s).

The specific examples of radiation-curable compounds include, e.g., (meth)acrylic esters, (meth)acrylamides, (meth)acrylic acid amides, allyl compounds, vinyl ethers and vinyl esters. “(Meth)acrylic” used here is a general term for acrylic and methacrylic.

As the specific examples of bifunctional radiation curable compounds, e.g., ethylene glycol di(meth)acrylate, propylene glycol di(meth)acrylate, butanediol di(meth)-acrylate, hexanediol di(meth)acrylate, diethylene glycol di(meth)acrylate, triethylene glycol di(meth)acrylate, tetraethylene glycol di(meth)acrylate, neopentyl glycol di(meth)acrylate, tripropylene glycol di(meth)acrylate, polyether (meth)acrylate, polyester (meth)acrylate, polyurethane (meth)acrylate, bisphenol A, bisphenol F, hydrogenated bisphenol A, hydrogenated bisphenol F, compounds obtained by adding (meth)acrylic acid to the alkylene oxide adducts of these compounds, alkylene oxide-modified isocyanuric acid di(meth)acrylate, and compounds having cyclic structure such as tricyclodecanedimethanol di(meth)acrylate are exemplified.

As the specific examples of trifunctional radiation curable compounds, trimethylolpropane tri(meth)acrylate, trimethylolethane tri (meth) acrylate, alkylene oxide-modified trimethylolpropane tri(meth)acrylate, pentaerythritol tri(meth)acrylate, dipentaerythritol tri(meth)acrylate, alkylene oxide-modified isocyanuric acid tri(meth)acrylate, propionic acid dipentaerythritol tri(meth)acrylate, and hydroxypival aldehyde-modified dimethylolpropane tri(meth)-acrylate are exemplified.

As the specific examples of tetrafunctional or more functional radiation-curable compounds, pentaerythritol tetra(meth)acrylate, ditrimethylolpropane tetra(meth)-acrylate, dipentaerythritol penta(meth)acrylate, propionic acid dipentaerythritol tetra(meth)acrylate, dipenta-erythritol hexa(meth)acrylate, and alkylene oxide-modified phosphagen hexa(meth)acrylate are exemplified.

Of the above radiation-curable compounds, bifunctional (meth) acrylate compounds having a molecular weight of from 200 to 2,000 are preferred, and alicyclic compounds such as dimethyloltricyclodecane, hydrogenated bisphenol A, and hydrogenated bisphenol F, bisphenol A, bisphenol F, and compounds obtained by adding (meth) acrylic acid to the alkylene oxide adducts of these compounds are more preferred.

The radiation-curable compounds used in an undercoat layer may be used in combination with the above binders.

When ultraviolet rays are used for the polymerization of these radiation-curable compounds, it is preferred to use a polymerization initiator. As the polymerization initiators, photo-radical polymerization initiators, photo-cationic polymerization initiators, and photo-amine generators can be used.

As the photo-radical polymerization initiators, α-diketones, e.g., benzyl and diacetyl; acyloins, e.g., benzoyl; acyloin ethers, e.g., benzoin methyl ether, benzoin ethyl ether, and benzoin isopropyl ether; thioxanthones, e.g., thioxanthone, 2,4-diethylthioxanthone, and thioxanthone-4-sulfonic acid; benzophenones, e.g., benzophenone, 4,4′-bis-(dimethylamino)benzophenone, and 4,4-bis(diethylamino)-benzophenone; Michler's ketones; acetophenones, e.g., acetophenone, 2- (4-toluenesulfonyloxy)-2-phenylacetophenone, p-dimethylaminoacetophenone, α,α′-dimethoxyacetoxybenzo-phenone, 2,2′-dimethoxy-2-phenylacetophenone, p-methoxy-acetophenone, 2-methyl[4-(methylthio)phenyl]-2-morpholino-1-propanone, and 2-benzyl-2-dimethylamino-1-(4-morpholino-phenyl)butan-1-one; quinones, e.g., anthraquinone and 1,4-naphthoquinone; halogen compounds, e.g., phenacyl chloride, trihalomethylphenylsulfone, and tris(trihalo-methyl)-s-triazine;acylphosphine oxides; and peroxides, e.g., di-t-butyl peroxide are exemplified.

As the specific examples of the photo-radical polymerization initiators, e.g., commercially available products, e.g., IRGACURE-184, 261, 369, 500, 651 and 907 (manufactured by Ciba Geigy Japan Limited), Darocur-1173, 1116, 2959, 1664 and 4043 (manufactured by Merck Japan Ltd.), KAyACURE-DETX, MBP, DMBI, EPA and OA (manufactured by Nippon Kayaku Co., Ltd.), VICURE-10 and 55 (STAUFFER CO., LTD.), TRIGONAL P1 (manufactured by AKZO CO., LTD.), SANDORAY 1000 (manufactured by SANDOZ CO., LTD.), DEAP (manufactured by APJOHN Co., LTD.), and QUANTACURE-PDO, ITX and EPD (manufactured by WARD BLEKINSOP CO., LTD.) are exemplified.

As the photo-cationic polymerization initiators, e.g., diazonium salts, triphenylsulfonium salts, metallocene compounds, diaryl iodonium salts, nitrobenzyl sulfonates, α-sulfonyloxy ketones, diphenyl disulfones, and imidyl sulfonates are exemplified.

As the specific examples of the photo-cationic polymerization initiators, commercially available products such as Adeka Ultraset PP-33, OPTOMER SP-150 and 170 (diazonium salts) (manufactured by Asahi Denka Kogyo Co., Ltd.), OPTOMER SP-150 and 170 (sulfonium salts) (manufactured by Asahi Denka Kogyo Co., Ltd.), and IRGACURE 261 (metallocene compound) (manufactured by Ciba Geigy Japan Limited) are exemplified.

As the photo-amine generators, e.g., nitrobenzyl carbamates and iminosulfonates are exemplified. These photo-polymerization initiators are arbitrarily selected in use in accordance with exposure conditions (e.g., whether the polymerization is performed in an oxygen atmosphere or an oxygen free atmosphere). These photo-polymerization initiators can also be used in combination of two or more.

When electron beams are used in polymerization of the radiation-curable compounds, a Van de Graaff type scanning system, a double scanning system or a curtain beam system can be used as the electron beam accelerator, but a curtain beam system is preferably used for the reason that it is relatively inexpensive and high output can be obtained. As electron beam characteristics, accelerating voltage is from 10 to 1,000 kV, preferably from 50 to 300 kV. Accelerating voltage of 10 kV or more is sufficient for the transmitting amount of energy. When accelerating voltage is 1,000 kV or less, the energy efficiency used in polymerization does not lower. Absorbed dose is from 0.5 to 20 Mrad, and preferably from 1 to 10 Mrad. When absorbed dose is 0.5 Mrad or more, sufficient strength can be obtained by the curing reaction, while when absorbed dose is 20 Mrad or less, the efficiency of energy used for curing does not lower and the compound to be irradiated does not generate heat, so that the deformation of the nonmagnetic support can be prevented.

On the other hand, when ultraviolet rays are used in the polymerization of the radiation-curable compounds, the dosage is preferably from 10 to 100 mJ/cm². When the dosage is 10 mJ/cm² or more, sufficient strength can be obtained by the curing reaction, while when the dosage is 100 mJ/cm² or less, reduction of the efficiency of energy used for curing and heat generation by the compound to be irradiated can be prevented, so that the nonmagnetic support is not deformed. Irradiation apparatus of ultraviolet rays (UV) and electron beams (EB) and the conditions of irradiation are described in UV·EB Koka Gijutsu (UV·EB Curing Techniques), published by Sogo Gijutsu Center, and Tei Energy Denshi-Sen Shosha no Oyo Gijutsu (Applied Techniques of Low Energy Electron Beam Irradiation), published by CMC Publishing Co, Ltd. (2000), and these known techniques can be used in the invention.

The binders and the radiation-curable compounds used for forming the undercoat layer may be used alone, or both may be used in combination. The addition amounts of the binder and the radiation-curable compound are, e.g., from 105 to 2,000 mass parts of the radiation-curable compound per 100 mass parts of the binder, preferably from 110 to 1,000 mass parts, and more preferably from 120 to 800 mass parts. When the blending amount of the radiation-curable compound to the binder is in the above range, leveling properties advantageous to undercoating can be ensured, and shrinkage on curing due to crosslinking can be prevented.

The undercoat layer can further contain electrically conductive powders and ionic surfactants for the purpose of preventing static electricity from occurring so that the magnetic recording medium is not charged with electricity. As the electrically conductive powders, e.g. , conductive metals, metallic compounds, carbon black and the like are exemplified. Specifically, metallic powders of gold, silver, platinum, palladium, nickel, etc.; metallic compounds, e.g., potassium titanate, tin oxide, antimony-containing tin oxide, zinc oxide, antimony oxide, tin-containing indium oxide, TiB₂, ZrB₂, TiC, TiN, etc.; and carbon blacks, e.g., furnace black, acetylene black, channel black, ketjen black, etc., are exemplified, and these powders can be used alone or two or more in combination. As the ionic surfactants, anionic surfactants such as long chain alkyl compounds having a sulfonate group, a sulfate group or a phosphate group, and cationic surfactants having a quaternized nitrogen compound are exemplified as low molecular weight ionic surfactants. As high molecular weight ionic surfactants, polymers having an ionized nitrogen atom on the main chain, and sulfonate-modified polystyrene are exemplified.

The composition comprising radiation-curable compounds, binders, polymerization initiators, and electrically conductive powders and ionic surfactants added according to necessity, for forming the undercoat layer is dissolved in a solvent to thereby prepare a coating solution. The solvent is not especially restricted and well-known organic solvents can be used. Drying of the undercoat layer may be either natural drying or heat drying. The undercoat layer can be formed by coating the coating solution on a nonmagnetic support and curing by irradiating the coated layer with radiation.

Thickness of Undercoat Layer:

The thickness of the undercoat layer is in the range of from 0.3 to 3.0 μm, preferably from 0.35 to 2.0 μm, and more preferably from 0.4 to 1.5 μm. The thickness of the undercoat layer depends upon the constituents, but the thickness is preferably the thinner so long as the surface property and physical strength of the coated layer can be secured.

Calender Treatment Method:

As another means of controlling surface waviness of a magnetic layer, a method of arbitrarily determining the conditions of calendering treatment of a magnetic recording medium is exemplified. The conditions of calendering treatment are, e.g., the pressure of calender, the temperature of calender, the kinds of calender rolls and the number of stages. The surface waviness of a magnetic layer can be controlled by arbitrarily selecting these conditions. Surface waviness generally becomes small by increasing calender pressure and calender temperature. Calender pressure is generally from 250 to 350 kg/cm (from 245 to 315 kN/m), and preferably from 280 to 330 kg/cm (from 274 to 323 kN/m). When calender temperature is too high, the lubricant on the surface of the magnetic layer is liable to evaporate, so that the temperature is generally from 60 to 130° C., and preferably from 85 to 110° C. By the increase of the number of calendering stages, surface waviness becomes small. As for the kinds of rolls, surface waviness is varied by the hardness of the surface of roll material. Surface waviness becomes great by a resin roll and becomes small by a metal roll. Various kinds of rolls can be used in combination and surface waviness can be arbitrarily controlled by the combination of the kinds of rolls and the number of stages.

The surface waviness (%) of the magnetic layer in the invention may be a value measured according to the following measuring conditions.

Measuring Conditions:

Measuring Instrument:

Three dimensional surface profiler, New View 5022™ manufactured by ZYGO Corporation

Measuring Method:

Scanning white light interferometry

Scan Length in Z Direction: 5 μm

Tension of a Sample at Measuring Time:

100 g per ½ inch in the machine direction

Area of Field of View in Measurement:

700 μm 522 μm (object lens: 20 magnifications, image zoom: 0.5 magnifications)

Filter Treatment:

High pass filter (HPF) 50 μm, low pass filter (LPF) OFF

Surface Waviness (%):

{[(The total of cross-sectional areas of the magnetic layer at the position 5 nm in the above direction from the average plane of surface waviness of the magnetic layer)+(the total of cross-sectional areas of the magnetic layer at the position 5 nm in the below direction from the average plane of surface waviness of the magnetic layer)] (μm²)/the area of field of view in measurement (μm²)}×100(%). The above direction means a direction from the nonmagnetic support toward the magnetic layer, and the below direction means a direction from the magnetic layer toward the nonmagnetic support.

The surface waviness (%) of the magnetic layer measured according to the above measuring conditions is from 3 to 15%, preferably from 3 to 10%, and more preferably from 3 to 8%. If the surface waviness is less than 3%, the coated layer of the magnetic layer is damaged for the reason that the frictional force in running increases, while when the surface waviness exceeds 15%, dropout increases, so that the object of the invention cannot be achieved.

The surface waviness is well known in the industry, which is the wavelength factor obtained by excluding the roughness factor in the section curve of magnetic layer surface. It has been found from the examination of the present inventor that the wavelength factors of particularly 50 μm or more of each wavelength factor forming magnetic layer surface influence error rate. Accordingly, in the invention, the wavelength factors of 50 μm or more are extracted from magnetic layer surface by the filter treatment of high pass filter (HPF) 50 μm. Incidentally, the average plane of surface waviness is the plane where the volumes of surface waviness having wavelength factors of 50 μm or more are equal. The surface waviness (%) is measured at ten points per a sample, and the average value is taken as the surface waviness. The average plane of surface waviness is defined so that the total volume of three-dimensional portions being above the average plane but below surface of the magnetic layer is equal to the total volume of three-dimensional portions being above surface of the magnetic layer but below the average plane. In this definition, the term “above” means a direction from the support to the magnetic layer and the term “below” means a direction from the magnetic layer to the support. The average plane is parallel to a surface of the support on which the magnetic layer is provided.

The constituents of the magnetic recording medium in the invention, e.g., a magnetic layer, a nonmagnetic layer and a nonmagnetic support, are explained in detail below.

Magnetic Layer:

As the ferromagnetic powders for use in a magnetic layer in the invention, ferromagnetic metal powders and hexagonal ferrite powders are exemplified, and ferromagnetic metal powders are especially preferably used. The particle size is preferably from 10 to 70 nm as average long axis length, and more preferably from 10 to 45 nm. When the particle size of ferromagnetic powders is in the above range, the packing density of the ferromagnetic powders is heightened, so that the high density recording characteristics of the magnetic recording medium can be increased.

Ferromagnetic Metal Powder:

Ferromagnetic metal powders for use in the magnetic layer of the invention are not especially restricted so long as they comprise α-Fe as the main component (including alloys), but ferromagnetic alloy powders comprising α-Fe as the main component are preferably used. These ferromagnetic powders may contain atoms, in addition to the prescribed atoms, e.g., Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr and B. It is preferred to contain at least one of Al, Si, Ca, Y, Ba, La, Nd, Co, Ni and B in addition to α-Fe, and it is especially preferred to contain Co, Al or Y. More specifically, it is preferred that the content of Co is preferably from 10 to 40 atomic % to Fe, the content of Al is from 2 to 20 atomic %, and the content of Y is from 1 to 15 atomic %.

These ferromagnetic metal powders may be previously treated with a dispersant, a lubricant, a surfactant, and an antistatic agent before dispersion. A small amount of water, hydroxide or oxide may be contained in ferromagnetic metal powders.

The shapes of ferromagnetic metal powders may be any of acicular, granular, ellipsoidal and tabular shapes, but it is especially preferred to use acicular ferromagnetic metal powders.

In the case of acicular ferromagnetic metal powders, the average long axis length is preferably from 10 to 70 nm, and more preferably from 10 to 45 nm. The acicular ratio is preferably from 2 to 7, and more preferably from 5 to 7. When ferromagnetic metal powders have the above particle size, the packing density of the ferromagnetic metal powders is heightened, so that the high density recording characteristics of the magnetic recording medium can be increased.

The crystallite size of ferromagnetic metal powders is preferably from 8 to 20 nm, more preferably from 10 to 18 nm, and still more preferably from 12 to 16 nm. The crystallite size is the average value obtained from the half value width of diffraction peak with an X-ray diffractometer (RINT 2000 series, manufactured by Rigaku Denki Co.) on the conditions of radiation source of CuKα1, tube voltage of 50 kv and tube current of 300 mA by Scherrer method.

Ferromagnetic metal powders have a specific surface area (SET) measured by BET method of preferably 40 m²/g or more and less than 80 m²/g, and more preferably from 40 to 70 m²/g.

When the specific surface area of ferromagnetic metal powders is in this range, good surface properties are compatible with low noise. The pH of ferromagnetic metal powders is preferably optimized by the combination with the binder to be used. The pH range is preferably from 4 to 12, and more preferably from 7 to 10. Ferromagnetic metal powders may be subjected to surface treatment with Al, Si, P or oxides of these metals, if necessary, and the amount of the surface-treating compound is from 0.1 to 20% based on the amount of the ferromagnetic metal powders. By the surface treatment, the adsorption amount of lubricant, e.g., fatty acid, becomes 100 mg/m² or less, and so preferred.

The coercive force (Hc) of ferromagnetic metal powders is preferably from 159.2 to 238.8 kA/m (from 2,000 to 3,000 Oe), and more preferably from 167.2 to 230.8 kA/m (from 2,100 to 2,900 Oe). The saturation magnetic flux density of ferromagnetic metal powders is preferably from 150 to 300 mT (from 1,500 to 3,000 G), and more preferably from 160 to 290 mT (from 1,600 to 2,900 G). The saturation magnetization (as) is preferably from 90 to 140 A·m²/kg (from 90 to 140 emu/g), and more preferably from 95 to 130 A·m²/kg (from 95 to 130 mu/g).

SFD (Switching Field Distribution) of magnetic powders themselves is preferably small, preferably 0.8 or less. When SFD is 0.8 or less, electromagnetic characteristics are excellent, high output can be obtained, magnetic flux revolution becomes sharp and peak shift becomes small, so that suitable for high density digital magnetic recording. To achieve smaller Hc distribution, making particle size distribution of goethite in ferromagnetic metal powders good, using monodispersed α-Fe₂O₃, and preventing sintering among particles are effective methods.

Ferromagnetic metal powders manufactured by well-known methods can be used in the invention, and such methods include a method of reducing a water-containing iron oxide having been subjected to sintering preventing treatment, or an iron oxide with reducing gas, e.g., hydrogen, to thereby obtain Fe or Fe—Co particles; a method of reducing a composite organic acid salt (mainly an oxalate) with reducing gas, e.g., hydrogen; a method of thermally decomposing a metal carbonyl compound; a method of reduction by adding a reducing agent, e.g., sodium boron hydride, hypophosphite or hydrazine, to an aqueous solution of a ferromagnetic metal; and a method of evaporating a metal in low pressure inert gas to thereby obtain fine powders. The thus-obtained ferromagnetic metal powders are subjected to well-known gradual oxidation treatment. As such treatment, a method of forming an oxide film on the surfaces of ferromagnetic metal powders by reducing a water-containing iron oxide or an iron oxide with reducing gas, e.g., hydrogen, and regulating partial pressure of oxygen-containing gas and inert gas, the temperature and the time is little in demagnetization and preferred.

Ferromagnetic Hexagonal Ferrite Powder:

The examples of ferromagnetic hexagonal ferrite powders include barium ferrite, strontium ferrite, lead ferrite and calcium ferrite, and Co substitution products of these ferrites. More specifically, magnetoplumbite type barium ferrite and strontium ferrite, magnetoplumbite type ferrites having covered the particle surfaces with spinel, and magnetoplumbite type barium ferrite and strontium ferrite partially containing spinel phase can be exemplified. Ferromagnetic hexagonal ferrite powders may contain, in addition to the prescribed atoms, the following atoms, e.g., Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge and Nb. In general, ferromagnetic hexagonal ferrite powders containing the following elements can be used, e.g., Co—Zn, Co—Ti, Co—Ti—Zr, Co—Ti—Zn, Ni—Ti—Zn, Nb—Zn—Co, Sb—Zn—Co and Nb—Zn. According to materials and manufacturing methods, specific impurities may be contained.

The particle size of ferromagnetic hexagonal ferrite powder is preferably from 10 to 60 nm, and more preferably from 10 to 45 nm, and the average tabular ratio [the average of (tabular diameter/tabular thickness)] is preferably from 1 to 15, and more preferably from 1 to 7. When the average tabular ratio is in the range of from 1 to 15, sufficient orientation can be attained while maintaining high packing density in a magnetic layer and, at the same time, the increase of noise due to stacking among particles can be prevented. The specific surface area (SB/BT) measured by BET method of particles in the above particle size range is from 10 to 200 m²/g. The specific surface area nearly coincides with the calculated value from the tabular diameter and the tabular thickness of a particle.

The distribution of tabular diameter·tabular thickness of ferromagnetic hexagonal ferrite powder particles is generally preferably as narrow as possible. The distribution of tabular diameter tabular thickness of particles can be shown in numerical values and compared by measuring 500 particles selected randomly from TEM photographs of particles. The distributions of tabular diameter·tabular thickness of particles are in many cases not regular distributions, but when it is expressed in the standard deviation to the average size by calculation, σ/average size is from 0.1 to 2.0. For obtaining narrow particle size distribution, it is efficient to make a particle-forming reaction system homogeneous as far as possible, and to subject particles formed to distribution improving treatment as well. For instance, a method of selectively dissolving superfine particles in an acid solution is also known.

The coercive force (Hc) of hexagonal ferrite particles is preferably from 161.6 to 400 kA/m (from 2,020 to 5,000 Oe), more preferably from 200 to 320 kA/m (from 2,500 to 4,000 Oe), and SFD is preferably from 0.3 to 0.7.

Coercive force (Hc) can be controlled by the particle size (tabular diameter·tabular thickness), the kinds and amounts of the elements contained in the hexagonal ferrite powder, the substitution sites of the elements, and the particle forming reaction conditions.

The saturation magnetization (σₛ) of hexagonal ferrite particles is preferably from 40 to 80 A·²/kg (emu/g). Saturation magnetization (σₛ) is preferably higher, but it has the inclination of becoming smaller as particles become finer. For improving saturation magnetization (σₛ), compounding spinel ferrite to magnetoplumbite ferrite, and the selection of the kinds and the addition amount of elements contained are well known. It is also possible to use W-type hexagonal ferrite. In dispersing magnetic powders, the particle surfaces of magnetic particles may be treated with dispersion media and substances compatible with the polymers. Inorganic and organic compounds are used as surface-treating agents. For example, oxides or hydroxides of Si, Al and P, various kinds of silane coupling agents and various kinds of titanium coupling agents are primarily used as such compounds. The addition amount of these surface-treating agents is from 0.1 to 10 mass % based on the mass of the magnetic powder. The pH of magnetic powders is also important for dispersion, and the pH is generally from 4 to 12 or so. The optimal value of the pH is dependent upon the dispersion media and the polymers. Taking the chemical stability and preservation stability of the medium into consideration, pH of from 6 to 11 or so is selected. The moisture content in magnetic powders also influences dispersion. The optimal value of the moisture content is dependent upon the dispersion media and the polymers, and moisture content of from 0.01 to 2.0% is selected in general.

The manufacturing methods of ferromagnetic hexagonal ferrite powders include the following methods and any of these methods can be used in the invention with no restriction: (1) a glass crystallization method of mixing metallic oxide which substitutes barium oxide, iron oxide, iron with boron oxide as a glass-forming material so as to make a desired ferrite composition, melting and then rapidly cooling the ferrite composition to obtain an amorphous product, treating by reheating, washing and pulverizing the amorphous product, to thereby obtain barium ferrite crystal powder; (2) a hydro-thermal reaction method of neutralizing a solution of the metallic salt of barium ferrite composition with an alkali, removing the byproducts produced, heating the liquid phase at 100° C. or more, washing, drying and then pulverizing, to thereby obtain barium ferrite crystal powder; and (3) a coprecipitation method of neutralizing a solution of the metallic salt of barium ferrite composition with an alkali, removing the byproducts produced and drying, treating the system at 1,100° C. or less, and then pulverizing to obtain barium ferrite crystal powder. Ferromagnetic hexagonal ferrite powders may be subjected to surface treatment with Al, Si, P or oxides of these metals, if necessary, and the amount of the surface-treating compound is from 0.1 to 10% based on the amount of the hexagonal ferrite powders. By the surface treatment, the adsorption amount of lubricant, e.g., fatty acid, preferably becomes 100 mg/m² or less. Hexagonal ferrite powders sometimes contain soluble inorganic ions of, e.g., Na, Ca, Fe, Ni and Sr, but it is preferred that these inorganic ions are not substantially contained. However, when the amount of inorganic ions is 200 ppm or less, the properties of hexagonal ferrite powders are not particularly affected.

Binder:

As the binders for use in a magnetic layer of the magnetic recording medium in the invention, well-known thermoplastic resins, thermosetting resins, reactive resins and mixtures of these resins are used.

The thermoplastic resins are resins having a glass transition temperature of −100 to 150° C., a number average molecular weight of from 1,000 to 200,000, preferably from 10,000 to 100,000, and the degree of polymerization of from about 50 to about 1,000. The examples of these thermoplastic resins include polymers or copolymers containing, as the constituting unit, vinyl chloride, vinyl acetate, vinyl alcohol, maleic acid, acrylic acid, acrylic acid ester, vinylidene chloride, acrylonitrile, methacrylic acid, methacrylic acid ester, styrene, butadiene, ethylene, vinyl butyral, vinyl acetal or vinyl ether; polyurethane resins and various rubber resins.

The examples of thermosetting resins and reactive resins include phenolic resins, epoxy resins, curable type polyurethane resins, urea resins, melamine resins, alkyd resins, acrylic reactive resins, formaldehyde resins, silicone resins, epoxy-polyamide resins, mixtures of polyester resins and isocyanate prepolymers, mixtures of polyester polyol and polyisocyanate, and mixtures of polyurethane and polyisocyanate. These resins are described in detail in Plastic Handbook, Asakura Shoten. It is also possible to use well-known electron beam-curable type resins in each layer. The examples of these resins and manufacturing methods are disclosed in detail in JP-A-62-256219.

These resins can be used alone or in combination. The examples of preferred combinations include at least one resin selected from vinyl chloride resins, vinyl chloride-vinyl acetate copolymers, vinyl chloride-vinyl acetate-vinyl alcohol copolymers, and vinyl chloride-vinyl acetate-maleic anhydride copolymers with a polyurethane resin, or combinations of these combinations with polyisocyanate.

Polyurethane resins having well known structures, e.g., polyester polyurethane, polyether polyurethane, polyether polyester polyurethane, polycarbonate polyurethane, polyester polycarbonate polyurethane, and polycaprolactone polyurethane can be used.

For the purpose of obtaining further excellent dispersibility and durability with respect to all the binders described above, it is preferred to use binders having at least one polar group selected from the following group and introduced by copolymerization or addition reaction, according to necessity, e.g., —COOH, —COO⁻M⁺, —SO₃H, —SO₃⁻M⁺, —OSO₃H, —OSO₃⁻M⁺, —P═O(OH)₂, —P═O(O⁻M⁺)₂, —O—P═O(H)₂, —O—P═O(O⁻M⁺)₂, —NR₂, —N⁺R₃, an epoxy group, —SH, and —CN (wherein M⁺ represents an alkali metal ion, R represents a hydrocarbon group). The content of the polar group is from 10⁻¹ to 10⁻⁸ mol/g, and preferably from 10⁻² to 10⁻⁶ mol/g. It is preferred for polyurethane resins to have at least one OH group at each terminal of the polyurethane molecule, i.e., two or more in total, besides the above polar groups. Since OH groups form a three dimensional network structure by crosslinking with a polyisocyanate curing agent, they are preferably contained in molecules as many as possible. In particular, it is preferred that OH groups are present at terminals of molecules, since the reactivity with the curing agent becomes high. It is preferred for polyurethane to have three or more OH groups, especially preferably four or more OH groups, at terminals of molecules.

When polyurethane is used in the invention, the polyurethane has a glass transition temperature of generally from −50 to 150° C., preferably from 0 to 100° C., and especially preferably from 30 to 100° C.; breaking extension of from 100 to 2,000%, breaking stress of generally from 0.05 to 10 kg/mm² (from 0.49 to 98 MPa or so), and a yielding point of from 0.05 to 10 kg/mm² (from 0.49 to 98 MPa or so). Due to these physical properties, a film having good mechanical properties can be obtained.

The specific examples of the binders for use in the invention include, as vinyl chloride copolymers, VAGH, VYHH, VMCH, VAGF, VAGD, VROH, VYES, VYNC, VMCC, XYHL, XYSG, PKHH, PKHJ, PKHC and PKFE (trade names, manufactured by Union Carbide Corp.), MPR-TA, MPR-TA5, MPR-TAL, MPR-TSN, MPR-TMF, MPR-TS, MPR-TM and MPR-TAO (trade names, manufactured by Nisshin Chemical Industry Co., Ltd.), 1000W, DX80, DX81, DX82, DX83 and 100FD (trade names, manufactured by Denki Kagaku Co., Ltd.), MR-104, MR-105, MR-110, MR-100, MR-555 and 400X-110A (trade names, manufactured by Nippon Zeon Co., Ltd.).

As polyurethane resins, the specific examples include Nippollan N2301, N2302 and N2304 (trade names, manufactured by Nippon Polyurethane Industry Co., Ltd.), Pandex T-5105, T-R3080, T-5201, BurnockD-400, D-210-80, Crisvon 6109 and 7209 (trade names, manufactured by Dainippon Ink and Chemicals Inc.), Vylon UR8200, UR8300, UR8700, RV530 and RV280 (trade names, manufactured by Toyobo Co., Ltd.), polyearbonate polyurethane, Daipheramine4020, 5020, 5100, 5300, 9020, 9022 and7020 (trade names, manufactured by Dainichiseika Color & Chemicals Mfg. Co., Ltd ), MX5004 (a trade name, manufactured by Mitsubishi Chemical Corporation), polyurethane, Sanprene SP-150 (a trade name, manufactured by Sanyo Chemical Industries, Ltd.), and Saran F310 and F210 (trade names, manufactured by Asahi Kasei Corporation).

The examples of polyisocyanates for use in the invention include isocyanates, e.g., tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate and triphenylmethane triisocyanate; addition products of these isocyanates with polyalcohols; and polyisocyanates formed by condensation reaction of isocyanates.

These isocyanates are commercially available under the trade names of Coronate L, Coronate HL, Coronate 2030, Coronate 2031, Millionate MR and Millionate MTL (manufactured by Nippon Polyurethane Industry Co., Ltd.), Takenate D-102, Takenate D-110N, Takenate D-200 and Takenate D-202 (manufactured by Takeda Chemical Industries, Ltd.), and Desmodur L, Desmodur IL, Desmodur N and Desmodur HL (manufactured by Sumitomo Bayer Co., Ltd.). These compounds may be used alone, or in combination of two or more in each layer including a magnetic layer taking advantage of the difference in curing reactivity.

The use amount of binders is generally in the range of from 5 to 50 mass parts per 100 mass parts of the ferromagnetic powder, and preferably from 10 to 30 mass parts. When vinyl chloride resins are used as a binder, the amount is generally in the range of from 5 to 30 mass % per 100 mass parts of the ferromagnetic powder, when polyurethane resins are used, the amount is generally in the range of from 2 to 20 mass % per 100 mass parts of the ferromagnetic powder, and it is preferred to use polyisocyanate in combination in the range of from 2 to 20 mass % per 100 mass parts of the ferromagnetic powder, however, for instance, when the corrosion of heads is caused by a slight amount of chlorine due to dechlorination, it is possible to use polyurethane alone or a combination of polyurethane and isocyanate alone.

The magnetic recording medium in the invention may be provided with two or more magnetic layers, or may be provided with a nonmagnetic layer. In such a case, the amount of binder, the amounts of vinyl chloride resin, polyurethane resin, polyisocyanate or other resins contained in the binder, the molecular weight of each resin constituting the magnetic layers, the amount of polar groups, or the physical properties of the above-described resins can of course be varied in each layer according to necessity. These factors should be rather optimized in each layer, and well-known techniques with respect to multilayer magnetic layers can be used in the invention. For example, when the amount of the binder is varied in each layer, it is effective to increase the amount of the binder contained in the magnetic layer to reduce scratches on the magnetic layer surface. For improving the head touch against the head, the amount of the binder in the later-described nonmagnetic layer can be increased to impart flexibility.

Carbon Black:

A magnetic layer in the invention can contain carbon blacks, if necessary. Carbon blacks have functions of static charge prevention, the reduction of friction coefficient, the impartation of a light-shielding property, and the improvement of film strength. These functions vary according to carbon blacks used. Accordingly, when the magnetic recording medium the invention takes a multilayer structure, it is of course possible to select and determine the kind, the amount and the combination of the carbon blacks to be added to each layer including a magnetic layer on the basis of the above various properties such as the particle size, the oil absorption amount, the electrical conductance and the pH value, or these should be rather optimized in each layer.

Carbon blacks used in a magnetic layer are furnace blacks for rubbers, thermal blacks for rubbers, carbon blacks for coloring, and acetylene blacks. Carbon blacks preferably have a specific surface area of from 5 to 500 m²/g, a DBP oil absorption amount of from 10 to 400 ml/100 g, an average particle size of from 5 to 300 nm, a pH value of from 2 to 10, a moisture content of from 0.1 to 10 mass %, and a tap density of from 0.1 to 1 g/ml.

The specific examples of commercially available carbon blacks include BLACKPEARLS 2000, 1300, 1000, 900, 905, 800, 880, 700, and VULCAN XC-72 (manufactured by Cabot Corporation), #80, #60, #55, #50 and #35 (manufactured by ASAHI CARBON CO., LTD.), #10B, #30, #40, #650B, #850B, #900, #950, #970B, #1000, #2300, #2400B, #3050B, #3150B, #3250B, #3750B, #3950B, and MA-600 (manufactured by Mitsubishi Chemical Corporation), CONDUCTEX SC, SC-U, RAVEN 15, 40, 50, 150, 1250, 1255, 1500, 1800, 2000, 2100, 3500, 5250, 5750, 7000, 8000, 8800, and RAVEN-MT-P (manufactured by Columbia Carbon Co., Ltd.), and Ketjen Black EC (manufactured by Akzo Co., Ltd.). With respect to carbon blacks that can be used in the invention, e.g., Carbon Black Binran (Handbook of Carbon Blacks), compiled by Carbon Black Kyokai can be referred to.

Carbon blacks may be surface-treated with a dispersant, or may be grafted with resins, or a part of the surface may be graphitized in advance before use. Carbon blacks may be previously dispersed in a binder before being added to a magnetic coating solution. Carbon blacks can be used alone or in combination. Carbon blacks are preferably used in the range of from 0.1 to 30 mass parts per 100 mass parts of the ferromagnetic powder.

Other Additives and the Like;

Additives having a lubricating effect, an antistatic effect, a dispersing effect and a plasticizing effect can be used in a magnetic layer in the invention.

For example, molybdenum disulfide, tungsten graphite disulfide, boron nitride, graphite fluoride, silicone oil, silicone having a polar group, fatty acid-modified silicone, fluorine-containing silicone, fluorine-containing alcohol, fluorine-containing ester, polyolefin, polyglycol, alkyl phosphoric acid ester and alkali metal salt thereof, alkyl sulfuric acid ester and alkali metal salt thereof, polyphenyl ether, phenylphosphonic acid, α-naphthylphosphoric acid, phenylphosphoric acid, diphenylphosphoric acid, p-ethylbenzenephosphonic acid, phenylphosphinic acid, aminoguinones, various kinds of silane coupling agents, titanium coupling agents, fluorine-containing alkylsulfuric acid ester and alkali metal salt thereof, monobasic fatty acids having from 10 to 24 carbon atoms (which may contain an unsaturated bond or may be branched) and metal salts thereof (e.g., with Li, Na, K, Cuand the like), mono-, di-, tri-, tetra-, penta- or hexa-alcohols having from 12 to 22 carbon atoms (which may contain an unsaturated bond or may be branched), alkoxy alcohol having from 12 to 22 carbon atoms (which may contain an unsaturated bond or may be branched), fatty acid monoester or fatty acid diester or fatty acid triester composed of a monobasic fatty acid having from 10 to 24 carbon atoms (which may contain an unsaturated bond or may be branched) and any one of mono-, di-, tri-, tetra-, penta- and hexa-alcohols having from 2 to 12 carbon atoms (which may contain an unsaturated bond or may be branched), fatty acid ester of monoalkyl ether of alkylene oxide polymerized product, fatty acid amides having from 8 to 22 carbon atoms, and aliphatic amines having from 8 to 22 carbon atoms are exemplified.

The specific examples of the fatty acids in these specific examples include capric acid, caprylic acid, lauric acid, myristic acid, palmitic acid, stearic acid, behenic acid, oleic acid, elaidic acid, linoleic acid, linolenic acid and isostearic acid.

The examples of the esters include butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentyl glycol didecanoate, and ethylene glycol dioleyl, and the examples of the alcohols include oleyl alcohol, stearyl alcohol and lauryl alcohol.

As additives, nonionic surfactants such as alkylene oxides, glycerols, glycidols, and alkylphenol-ethylene oxide adducts; cationic surfactants such as cyclic amines, ester amides, quaternary ammonium salts, hydantoin derivatives, heterocyclic rings, phosphoniums, and sulfoniums; anionic surfactants containing an acid radical, e.g., carboxylic acid, sulfonic acid, phosphoric acid, sulfuric acid ester groups and phosphoric acid ester groups; and ampholytic surfactants such as amino acids, aminosulfonic acids, sulfuric or phosphoric acid esters of amino alcohols, and alkylbetaines can also be used. The details of these surfactants are described in Kaimen Kasseizai Binran (Handbook of Surfactants), Sangyo Tosho Publishing Co., Ltd.

The above organic phosphoric acid compounds such as phenylphosphonic acid and benzylphosphonic acid are added to the magnetic layer of the magnetic recording medium of the invention as a dispersant.

These additives need not be 100% pure and may contain impurities such as isomers, unreacted products, byproducts, decomposed products and oxides, in addition to the main components. However, the content of such impurities is preferably 30 mass % or less, and more preferably 10 mass % or less.

These additives for use in the invention respectively have different physical functions. The kinds, amounts and combining proportions bringing about synergistic effects of these additives should be determined optimally in accordance with the purpose.

In general, the total amount of additives is from 0.1 to 50 mass % based on the amount of the ferromagnetic powder in a magnetic layer, and preferably from 2 to 25 mass %. Incidentally, it is preferred to control the amount of free P in the coating layer of the magnetic recording medium in the invention as described above.

All or a part of the additives used in the invention may be added in any step of the preparation of a magnetic layer coating solution or a nonmagnetic layer coating solution described later. For example, additives may be blended with magnetic powder before a kneading step, may be added in a step of kneading magnetic powder, a binder and a solvent, may be added in a dispersing step, may be added after a dispersing step, or may be added just before coating. According to purpose, there are cases of capable of attaining the object by coating all or a part of the additives after the coating of a magnetic layer or simultaneously with the coating. Further, according to purpose, additives can be coated on the surface of a magnetic layer after calendering treatment, or after the completion of slitting.

The thickness of a magnetic layer is preferably from 0.05 to 0.15 μm, and more preferably from 0.10 to 0.15 μm.

Nonmagnetic Support:

The nonmagnetic support for use in the invention is preferably a flexible support, and well-known films such as polyesters, e.g., polyethylene terephthalate (PET) and polyethylene naphthalate (PEN), polyolefins, and aromatic polyamides, e.g., cellulose triacetate, polyearbonate, polyamide, polyimide, polyamideimide, polysulfone and Aramid can be used. These supports may be subjected in advance to corona discharge treatment, plasma treatment, adhesion assisting treatment, heating treatment or dust-removing treatment. For achieving the object of the invention, it is preferred that the support generally has a central line average surface roughness of 0.03 μm or less, preferably 0.02 μm or less, and more preferably 0.01 μm or less. It is also preferred that the support not only has a small central line average surface roughness but also is free from coarse spines having a height of 1 μm or more. Surface roughness configuration is freely controlled by the size and the amount of fillers added to the support. The examples of fillers include oxides and carbonates of Ca, Si and Ti, and acrylic organic fine powders.

The thickness of the nonmagnetic support is preferably from 3 to 8 μm, and more preferably from 3 to 6 μm.

Magnetic recording media having a magnetic layer on one side of a nonmagnetic support are widely included in the magnetic recording media in the invention. Magnetic recording media having layers other than a magnetic layer are included in the magnetic recording media in the invention. For example, a backing layer provided on the opposite side of a magnetic layer, a nonmagnetic layer containing nonmagnetic powder, a soft magnetic layer containing soft magnetic powder, a second magnetic layer, a cushioning layer, an overcoat layer, an adhesive layer and a protective layer are exemplified as such other layers. These layers can be provided at proper positions so as to effectively exhibit their functions.

Nonmagnetic Layer:

As the preferred magnetic recording medium in the invention, a magnetic recording medium having a nonmagnetic layer containing nonmagnetic inorganic powder and a binder provided between a nonmagnetic support and a magnetic layer is exemplified.

Nonmagnetic Inorganic Powder:

The nonmagnetic inorganic powder can be selected from inorganic compounds, e.g., metallic oxides, metallic carbonates, metallic sulfates, metallic nitrides, metallic carbides and metallic sulfides, and nonmagnetic metals.

The examples of the inorganic compounds are selected from the following compounds and they can be used alone or in combination, e.g., titanium oxides (TiO₂, TiO), α-alumina having an α-conversion rate of from 90 to 100%, β-alumina, γ-alumina, α-iron oxide, chromium oxide, zinc oxide, tin oxide, tungsten oxide, vanadium oxide, silicon carbide, cerium oxide, corundum, silicon nitride, titanium carbide, silicon dioxide, magnesium oxide, zirconium oxide, boron nitride, calcium carbonate, calcium sulfate, barium sulfate, molybdenum disulfide, goethite, and aluminum hydroxide. Titanium dioxide, zinc oxide, iron oxide and barium sulfate are especially preferred, and titanium dioxide and iron oxide are more preferred. As the nonmagnetic metals, Cu, Ti, Zn and Al are exemplified.

The average particle size of these nonmagnetic inorganic powders is preferably from 0.005 to 2 μm but, if necessary, nonmagnetic powders each having a different average particle size may be combined, or single nonmagnetic powder having broad particle size distribution may be used so as to obtain the same effect as such a combination. Particularly preferred nonmagnetic powders are those having an average particle size of from 0.01 to 0.2 μm. Nonmagnetic powders have a pH value of especially preferably from 6 to 9, a specific surface area of from 1 to 100 m²/g, preferably from 5 to 50 m²/g, and more preferably from 7 to 40 m²/g, a crystallite size of from 0.01 to 2 μm, an oil absorption amount using DBP of preferably from 5 to 100 ml/100 g, more preferably from 10 to 80 ml/100 g, and still more preferably from 20 to 60 ml/100 g, and a specific gravity of preferably from 1 to 12, and more preferably from 3 to 6. The shape of the nonmagnetic powders may be any of acicular, spindle, spherical, polyhedral and tabular forms.

The binders, lubricants, dispersants, additives, solvents, dispersing methods and others used in the above described magnetic layers can be used in the nonmagnetic layer. In particular, with respect to the amounts and kinds of binders, and the amounts and kinds of additives and dispersants, well-known techniques used in magnetic layers can be applied to the nonmagnetic layer.

The thickness of the nonmagnetic layer is preferably from 0.5 to 3 μm, and more preferably from 0.5 to 2 μm. It is preferred for the thickness of the nonmagnetic layer to be thicker than the thickness of the magnetic layer.

When a backing layer is provided, it is preferred that carbon blacks and inorganic powders are contained in the backing layer. The prescriptions of the binders and various kinds of additives used in the magnetic layer and the nonmagnetic layer are applied to the backing layer. The thickness of the backing layer is preferably from 0.1 to 1.0 μm, and more preferably from 0.4 to 0.6 μm.

Manufacture of Magnetic Recording Medium:

The magnetic recording medium in the invention can be manufactured by, e.g., coating each coating solution on the surface of a nonmagnetic support under running so that the layer thickness after drying comes into the prescribed range. A plurality of coating solutions for forming a magnetic or a nonmagnetic layer may be multilayer-coated sequentially or simultaneously.

Air doctor coating, blade coating, rod coating, extrusion coating, air knife coating, squeeze coating, immersion coating, reverse roll coating, transfer roll coating, gravure coating, kiss coating, cast coating, spray coating and spin coating can be used for coating. Regarding these methods, e.g., Saishin Coating Gijutsu (The Latest Coating Techniques), Sogo Gijutsu Center (May 31, 1983) can be referred to.

A coated magnetic layer is dried after the ferromagnetic powder contained in the magnetic layer has been subjected to magnetic field orientation treatment. The magnetic field orientation treatment can be performed at one's discretion by well-known methods in the industry.

The obtained magnetic recording medium can be cut with a cutter and the like in a desired size and used.

The magnetic recording medium in the invention can be especially preferably applied to a magnetic recording or reproducing apparatus using an MR head. Since the leakage flux from a magnetic recording medium becomes small by increasing recording density high, it is necessary to use an MR head capable of obtaining high output even with a minute magnetic flux as a reproducing head, but conventional high density (digital) recording at recording wavelength of 0.3 μm or less is accompanied with the increase of an error rate. However, in the magnetic recording medium in the invention, spacing loss is reduced by controlling the surface waviness of the magnetic layer, so that dropout is little even when recording wavelength is, e.g., from 0.05 to 0.3 μm, and excellent in error rate. Accordingly, it becomes possible to excellently reproduce recorded information with an MR head.

### EXAMPLES

The invention will be described in detail with reference to Examples and Comparative Examples, but the invention is not limited thereto. In the examples “parts” means “mass parts” unless otherwise indicated.

### Example 1

Preparation of Upper Magnetic Layer-Forming Coating Solution and Lower Nonmagnetic Layer-Forming Coating Solution

Constituents for Forming Upper Magnetic Layer:

| | | |
|---|---|---|
| Ferromagnetic metal powder | 100 | parts |
| Composition: Fe/Co = 100/30 (atomic ratio) | | |
| Hc: 189.600 kA/m (2,400 Oe) | | |
| Specific surface area (S_{BET}): 62 m²/g | | |
| Average long axis length: 45 nm | | |
| Crystallite size: 11 nm (110 Å) | | |
| Saturation magnetization (σₛ): 117 A · m²/kg | | |
| (117 emu/g) | | |
| pH: 9.3 | | |
| Co/Fe: 25 atomic % | | |
| Al/Fe: 7 atomic % | | |
| Y/Fe: 12 atomic % | | |
| Vinyl chloride copolymer | 12 | parts |
| (MR-110, manufactured by Nippon Zeon | | |
| Co., Ltd.) | | |
| —SO3Na group content: 5 × 10⁻⁶ eq/g | | |
| Polymerization degree: 350 | | |
| Epoxy group (3.5 mass % in a monomer unit) | | |
| Polyester-polyurethane resin | 3 | parts |
| (UR-8200, manufactured by Toyobo Co., Ltd.) | | |
| α-Alumina (average particle size: 0.1 μm) | 5 | parts |
| Carbon black (average particle size: 0.08 μm) | 0.5 | parts |
| Stearic acid | 2 | parts |
| Methyl ethyl ketone | 90 | parts |
| Cyclohexane | 30 | parts |
| Toluene | 60 | parts |

Constituents for Forming Lower Nonmagnetic Layer:

| | | |
|---|---|---|
| Nonmagnetic powder, α-Fe₂O₃ hematite | 80 | parts |
| Average long axis length: 0.15 μm | | |
| Specific surface area (S_{BET}): 58 m²/g | | |
| Average acicular ratio: 7.5 | | |
| Carbon black (manufactured by Mitsubishi | 20 | parts |
| Carbon Co., Ltd.) | | |
| Average primary particle size: 16 nm | | |
| DBP oil absorption amount: 80 ml/100 g | | |
| pH: 8.0 | | |
| Specific surface area (S_{BET}): 250 m²/g | | |
| Volatile content: 1.5% | | |
| Vinyl chloride copolymer | 12 | parts |
| (MR-110, manufactured by Nippon Zeon | | |
| Co., Ltd.) | | |
| Polyester-polyurethane resin | 12 | parts |
| (UR-8200, manufactured by Toyobo Co., Ltd.) | | |
| Stearic acid | 2 | parts |
| Methyl ethyl ketone | 150 | parts |
| Cyclohexane | 50 | parts |
| Toluene | 50 | parts |

Each component for forming the upper layer and the lower layer was kneaded in a kneader and then dispersed in a sand mill. Secondary butyl stearate (sec-BS) (1.6 parts) was added to the upper layer dispersion and 3 parts of polyisocyanate (Coronate L, manufactured by Nippon Polyurethane Co., Ltd.) was added to the lower layer dispersion, and further 40 parts of a mixed solution of methyl ethyl ketone and cyclohexanone was added to respective solutions. Each solution was filtered through a filter having an average pore diameter of 1 μm to prepare coating solutions for forming an upper magnetic layer and a lower nonmagnetic layer.

### Preparation of Coating Solution for Forming Undercoat Layer:

Trifunctional polyether acrylate (molecular weight: 584, coefficient of viscosity: 980 cP (0.98 Pa·s)) was added to methyl ethyl ketone in proportion of the acrylate of 30 mass %.

### Preparation of Coating Solution for Forming Backing Layer

Constituents for Forming Backing Layer:

| | | |
|---|---|---|
| Fine particle carbon black | 100 | parts |
| Average particle size: 17 nm | | |
| Coarse particle carbon black | 10 | parts |
| Average particle size: 270 nm | | |
| Nitrocellulose resin | 100 | parts |
| Polyester polyurethane resin | 30 | parts |
| Dispersant | | |
| Copper oleate | 10 | parts |
| Copper phthalocyanine | 10 | parts |
| Barium sulfate (precipitating) | 5 | parts |
| Methyl ethyl ketone | 500 | parts |
| Toluene | 500 | parts |
| α-Alumina | 0.5 | parts |
| Average particle size: 0.13 μm | | |

Each component was kneaded in a continuous kneader and then dispersed in a sand mill. Polyisocyanate (Coronate L, manufactured by Nippon Polyurethane Co., Ltd.) (40 parts) and 1,000 parts of methyl ethyl ketone were added to the obtained dispersion, and the mixture was filtered through a filter having an average pore diameter of 1 μm to prepare a coating solution for forming a backing layer.

### Preparation of Magnetic Tape, and Manufacturing Method

The obtained undercoat layer-forming coating solution was coated on the magnetic layer coating side of a polyethylene terephthalate (PET) nonmagnetic support (a thickness: 6 μm, the surface waviness of the surface on which a magnetic layer is coated: 20%) by a coil bar in a dry thickness of 0.5 μm, dried, and then the coated layer surface was irradiated with an electron beam of accelerating voltage of 150 kV so that the absorbed dose became 1 Mrad to be hardened.

Subsequently, the above-obtained upper magnetic layer-forming coating solution and the lower nonmagnetic layer-forming coating solution were simultaneously coated by multilayer coating on the undercoat layer in a dry thickness of the lower layer of 1.4 μm and that of the upper magnetic layer of 0.15 μm.

Orientation treatment was performed while both layers were still wet with a cobalt magnet having a magnetic flux density of 3,000 gauss (300 mT) and a solenoid having a magnetic flux density of 1,500 gauss (150 mT). After that, both layers were dried, and a nonmagnetic layer and a magnetic layer were formed.

The backing layer-forming coating solution was coated in a dry thickness of 0.5 μm on the other side of the support and dried to form a backing layer, whereby a magnetic recording lamination roll having the nonmagnetic layer and the magnetic layer on one side and the backing layer on the other side of the support was obtained.

The thus-obtained magnetic recording lamination roll was subjected to calendering process through a seven stage calendering processor consisting of a heating metal roll and an elastic roll comprising a thermosetting resin covering a core bar (temperature: 90° C., linear pressure: 300 kg/cm (294 kN/m), a processing rate of 300 m/min.). After calendering process, the magnetic recording lamination roll was slit to 0.5 inch in width, and subjected to demagnetization by passing through a solenoid having a magnetic flux density of 3,000 gauss (300 mT) to obtain a magnetic tape.

### Example 2

The procedure in Example 1 was repeated, except that the acrylate in the undercoat layer-forming coating solution was replaced with hexa-functional polyether acrylate (molecular weight: 593, coefficient of viscosity: 6,800 cP (6.8 Pa·s)).

### Example 3

The procedure in Example 1 was repeated, except that the acrylate in the undercoat layer-forming coating solution was replaced with penta-functional polyether acrylate (molecular weight: 525, coefficient of viscosity: 13,600 cP (13.6 Pa·s)).

### Comparative Example 1

The procedure in Example 1 was repeated, except that the acrylate in the undercoat layer-forming coating solution was replaced with bifunctional polyurethane acrylate (molecular weight: 2,300, coefficient of viscosity: 45,000 cP (45 Pa·s)).

### Comparative Example 2

The procedure in Example 1 was repeated, except that the linear pressure of calendering process was changed to 400 kg/cm (394 kN/m).

Evaluation of Tape:

The magnetic tapes obtained in Examples and Comparative Examples were evaluated according to the following measuring conditions. The results obtained are shown in Table 1 below.

Surface Waviness:

The surface waviness in the invention is a value measured according to the following measuring conditions, and measured at ten points per a sample, and the average value is taken as the surface waviness.

Measuring Instrument:

Three dimensional surface profiler New View 5022 manufactured by ZYGO Corporation

Measuring Method:

Scanning white light interferometry

Scan Length in Z Direction: 5 μm

Tension of a Sample at Measuring Time: 100 g per ½ Inch

Area of Field of View in Measurement:

700 μm×522 μm (object lens: 20 magnifications, image zoom: 0.5 magnifications)

Filter Treatment:

High pass filter (HPF) 50 μm, low pass filter (LPF) OFF

Surface Waviness (%):

{[(The total of cross-sectional areas of the magnetic layer at the position 5 nm in the above direction from the average plane of surface waviness of the magnetic layer)+(the total of cross-sectional areas of the magnetic layer at the position 5 nm in the below direction from the average plane of surface waviness of the magnetic layer)] (μm²)/the area of field of view in measurement (μm²)}×100(%).

Number of Dropout:

Dropout (DO) was measured with a drum tester. Signal of a recording wavelength of 0.3 μm was wrote in with an MIG head of 1.5 T and reproduced with an MR head. Output obtained was analyzed with a spectrum analyzer, and the case where the output was reduced by 50% was taken as dropout, and the counted number was converted in terms of DO number per 1 m. Five dropouts/m or less was graded good.

Damage of Film:

A magnetic tape was laid over SUS 420J of 4 mmφ at an angle of 180° so that the magnetic layer surface was brought into contact, and the tape was slid on the conditions of a load of 50 g and a rate of 20 mm/s. The scratch of the magnetic layer surface after 500 passes was observed visually and stereoscopically, and the degree of the scratch was evaluated as follows.
o: Scratch was not observed.

x: Scratch was observed.

TABLE 1

| | Surface | | |
|---|---|---|---|
| | Waviness | Number of | |
| | of Magnetic | Dropout | Damage |
| Example No. | Layer of Tape | (number/m) | of Film |
| Example 1 | 4 | 1.7 | ◯ |
| Example 2 | 9 | 3.5 | ◯ |
| Example 3 | 13 | 4.8 | ◯ |
| Comparative | 17 | 7.2 | ◯ |
| Example 1 | | | |
| Comparative | 2 | 0.7 | X |
| Example 2 | | | |

As is apparently seen from the results in Table 1, dropout can be conspicuously reduced by the control of the surface waviness of a magnetic layer. Damage of film can also be restrained by controlling the surface waviness of a magnetic layer.

This application is based on Japanese Patent application JP 2005-19330, filed Jan. 27, 2005, the entire content of which is hereby incorporated by reference, the same as if set forth at length.

What is claimed is:

1. A magnetic recording medium comprising:
a nonmagnetic support; and
a magnetic layer comprising a binder and ferromagnetic powder dispersed in the binder,
wherein the magnetic layer has a surface waviness of from 3 to 15%, the surface waviness being calculated by {[(a total of cross-sectional areas of the magnetic layer at a position 5 nm in an above direction from an average plane of surface waviness of the magnetic layer)+(a total of cross-sectional areas of the magnetic layer at a position 5 nm in a below direction from the average plane of surface waviness of the magnetic layer)] (μm²)/a area of a surface of the magnetic layer to be measured (μm²)}×100(%).

2. The magnetic recording medium according to claim 1, wherein the surface waviness is measured at a tension of a sample of 100 g per ½ inch.

3. The magnetic recording medium according to claim 1, wherein the surface waviness is measured according to the following measuring conditions:
Measuring instrument:
Three dimensional surface profiler New View 5022 manufactured by ZYGO Corporation
Measuring method:
Scanning white light interferometry
Scan length in Z direction: 5 μm
Tension of a sample at measuring: 100 g per ½ inch
Area of field of view in measurement:
700 μm×522 μm (object lens: 20 magnifications, image zoom: 0.5 magnifications)
Filter treatment:
High pass filter 50 μm, low pass filter OFF
Surface waviness (%):
{[(a total of cross-sectional areas of the magnetic layer at a position 5 nm in an above direction from an average plane of surface waviness of the magnetic layer)+(a total of cross-sectional areas of the magnetic layer at a position 5 nm in a below direction from the average plane of surface waviness of the magnetic layer)] (μm²)/the area of field of view in measurement (μm²)}×100(%).

4. The magnetic recording medium according to claim 1, wherein the surface waviness is from 3 to 10%.

5. The magnetic recording medium according to claim 2, wherein the surface waviness is from 3 to 10%.

6. The magnetic recording medium according to claim 3, wherein the surface waviness is from 3 to 10%.

7. The magnetic recording medium according to claim 1, wherein the surface waviness is from 3 to 8%.

8. The magnetic recording medium according to claim 2, wherein the surface waviness is from 3 to 8%.

9. The magnetic recording medium according to claim 3, wherein the surface waviness is from 3 to 8%.

10. The magnetic recording medium according to claim 1, further comprising a nonmagnetic layer between the nonmagnetic support and the magnetic layer, the nonmagnetic layer containing a binder and nonmagnetic inorganic powder dispersed in the binder.

11. The magnetic recording medium according to claim 2, further comprising a nonmagnetic layer between the nonmagnetic support and the magnetic layer, the nonmagnetic layer containing a binder and nonmagnetic inorganic powder dispersed in the binder.

12. The magnetic recording medium according to claim 3, further comprising a nonmagnetic layer between the nonmagnetic support and the magnetic layer, the nonmagnetic layer containing a binder and nonmagnetic inorganic powder dispersed in the binder.

13. The magnetic recording medium according to claim 1, wherein the ferromagnetic powder is ferromagnetic metal powder having an average long axis length of from 20 to 70 nm.

14. The magnetic recording medium according to claim 2, wherein the ferromagnetic powder is ferromagnetic metal powder having an average long axis length of from 20 to 70 nm.

15. The magnetic recording medium according to claim 3, wherein the ferromagnetic powder is ferromagnetic metal powder having an average long axis length of from 20 to 70 nm.

16. The magnetic recording medium according to claim 1, wherein the magnetic layer has a thickness of from 0.01 to 0.15 μm.

17. The magnetic recording medium according to claim 2, wherein the magnetic layer has a thickness of from 0.01 to 0.15 μm.

18. The magnetic recording medium according to claim 3, wherein the magnetic layer has a thickness of from 0.01 to 0.15 μm.

19. A method comprising: recording or reproducing an information with the magnetic recording medium as claimed in claim 1, in which the reproducing is made with a reproducing head including a magneto-resistive element.

20. The method according to claim 14, wherein the recording is made at a recording wavelength of information of from 0.05 to 0.30 μm.
